(19) United States
(12) Patent Application Publication
(10) Pub. No.: US 2006/0235728 A1
(43) Pub. Date: Oct. 19, 2006

(54) System and method for improved medical billing, payment, record keeping and patient care

(76) Inventor: Kumar Patel Yogesh, Dresden, TN (US)

Correspondence Address: ROBERT D. GUNDERMAN, JR.;PATENT TECHNOLOGIES, LLC, 150 LUCIUS GORDON DRIVE, SUITE 205, WEST HENRIETTA, NY, 14586, US

(21) Appl. No.: 11/301,201

(22) Filed: Dec. 12, 2005

Related U.S. Application Data
(60) Provisional application No. 60/671,414, filed on Apr. 14, 2005.

(51) Int. Cl. G06F 19/00; G06Q 40/00; G07C 1/10

(52) U.S. Cl. 705/3; 705/32; 705/4

(57) ABSTRACT

A system and method for improved medical billing, payment, record keeping and patient care. The system and method includes a patient room computer containing a time clock algorithm, an electronic card reader connected to the patient room computer for reading a patient electronic card and for providing patient information contained on the patient electronic card to the patient room computer, a medical practitioner electronic security key operatively coupled to the time clock algorithm, a digital audio recording and storage device coupled to the patient room computer for recording and storing discussions between a medical practitioner and a patient, and a means for activating the digital audio recording and storage device when a medical practitioner enters a patient room.

### CROSS-REFERENCE TO RELATED PATENT APPLICATIONS

This application claims the benefit of the filing date of U.S. Provisional patent application Serial No. U.S. Ser. No. 60/671,414 filed on Apr. 14, 2005.

### BACKGROUND OF THE INVENTION

1. Field of the Invention

This invention relates in one embodiment to a method of doing business, and more particularly but not exclusively to a system and method for improved medical billing, payment, record keeping and patient care.

2. Description of the Related Art

The current health care system in the United States uses complex billing terminology based on Current Procedural Terminology (CPT), a system of numeric codes that has been developed and maintained by the American Medical Association (AMA) in connection with the Health Care Financing Administration (HCFA) Common Procedure Coding System. Using Current Procedural Terminology (CPT), medical services are described using numeric codes. These numeric codes have been established in the United States as the standard code set for reporting health care services in electronic transactions.

The use of Current Procedural Terminology (CPT) codes were also designed to assist in the assignment of reimbursement amounts to providers of medical services by Medicare carriers. Today, many managed care and insurance companies base their reimbursements on the values established by the Health Care Financing Administration (HCFA).

The current system of Current Procedural Terminology (CPT) codes has become highly complicated. Appropriate definitions for the codes and accurate reimbursement amounts for each code have become increasingly difficult, and frequently change. In addition, a medical practitioner consumes an inordinate amount of time keeping up with the codes and associated record keeping, which leaves less time available for patient care.

The Current Procedural Terminology (CPT) codes use International Classification of Diseases (ICD) terminology developed by the World Health Organization. In addition, there are numerous levels of office visit types called Evaluation and Management Codes (E&M Codes) that are used as part of the Current Procedural Terminology (CPT) code system.

The Current Procedural Terminology (CPT) Coding system and International Classification of Diseases (ICD) Terminology are highly complex, time consuming, and expensive. It is estimated that thirty to forty percent of total healthcare dollars in the United States are spent toward the management and upkeep of this complicated system. With healthcare costs in the United States approaching one trillion dollars a year, a thirty to forty percent reduction in this cost can save in excess of 300 billion dollars a year.

The deficiencies and problems associated with the Current Procedural Terminology (CPT) Coding System and associated International Classification of Diseases (ICD) are numerous. The applicant has provided several examples of these deficiencies and problems that are commonly known to those in the medical community in the United States.

The current CPT/ICD system requires unnecessary and extensive documentation and associated physician time that costs medical offices a great deal of time and money.

Under the current CPT/ICD system there are too many codes for the care of patients and patient visits, making the current CPT/ICD system difficult or impossible to understand. There are currently more than 15 levels of codes for medical office visits known as Evaluation and Management (E & M) codes. There are hundreds of other codes to provide for other treatments such as injections, sutures, lab work, X-Rays, Electrocardiograms, etc. These hundreds of codes are very confusing and completely unnecessary, causing not only severe frustration to doctors but costing billions of dollars a year in unnecessary paperwork, and further taking precious Physician time and focus away from patient care.

Under the CPT/ICD system, a medical practitioner in the same office is paid the same amount regardless of their qualification. A physician assistant, general practitioner, specialist, or sub-specialist each receives the same payment for a particular CPT code under the current CPT/ICD system. The current CPT/ICD system does not take into consideration whether the provider is fresh out of school or has years of experience. This disregard for the experience level of a practitioner is very inequitable, and is not good for patients or medical providers. For example, if a patient is charged a level 3 visit (CPT Code 99213), the payment to the practitioner is the same regardless of whether the practitioner is a midlevel just out of school and not a Doctor, or a super specialist with years of training and experience. This inequity promotes inefficiencies of service that negatively impact both the patient and the practitioner.

The current CPT/ICD system requires a separate billing department in medical offices and hospitals, costing huge amounts of money for the personnel required, computer systems and software, and related expenses.

The current CPT/ICD system is so complicated and intricate that most providers (Physicians) and all consumers (patients) have no idea what the charges are for, or what the cost of any service is. A hard working Physician can easily work for hours without knowing what revenue he is generating, if he will ever get paid for the services, or what his net income would be after overhead costs.

Use of the current CPT/ICD system involves excess layers of cost that can consume sixty to seventy percent of a physician's revenues in non-productive areas that have nothing to do with actual patient care. To compensate for these excess layers of cost, many Physicians and other providers engage in areas such as diagnostics, ancillary services, and the like, to generate extra revenues that are needed to compensate for this imbalance. These practices lead to over utilization of ancillaries, errors and increasing patient demands. The increasing patient demands result from the fact that patients are most demanding to have a test done when it is free and readily available. The addition of ancillary services, diagnostics, and the like all contribute to more complexity in medical services and billing, with resulting confusion and excess costs.

The documentation demanded by the current CPT/ICD system requires a complex record keeping system, dictation and typing costs, delays in billing, and a tremendous amount of pressure and extra work on Doctors that has no relation to patient care. The excessive documentation demands created by the current CPT/ICD system is not only expensive but also leads to false documentation, errors in record keeping, and ultimately in ammunition for malpractice lawyers.

It is impossible to comply with the current CPT/ICD system requirements of documenting everything a Physician does for a patient so that the physician will get paid for a particular service. If a physician has several sick patients waiting to be seen he is typically unable to sit down and document everything he has done. At the end of a busy day after taking care of 20 to 30 patients it is impossible for a Physician to remember exactly what he did for patient # 4 or # 8 and so on. This leads to fabrication and errors in records by physicians just to create enough data so their work can get paid under the current CPT/ICD system. This situation is not good for anybody, very frustrating for Doctors, and counterproductive for the whole health care environment.

The excessive requirements for documentation as imposed by the current CPT/ICD system, and the subsequent costly process of billing and collection, leads to a tremendous strain on medical offices in the United States. Billing, collection and record keeping has become a parallel industry to health care that imposes a huge cost and time burden on medical offices, and the entire medical system in the United States. These burdensome requirements are negatively impacting patient care. Dollars spent in this worthless process create no value in actually improving patient care or providing better medical services. This aspect of medicine has become a major distraction to most Doctors and is taking important Doctor time away from the patient. If the current CPT/ICD system allows 15 minutes of billable time for a particular code, most Doctors are forced to spend almost 30 to 40% of this time in documenting and record keeping to comply with the CPT/ICD system requirements. Doctors, in keeping with their professional responsibilities, will always place patient care ahead of fulfilling these bureaucratic requirements of the current CPT/ICD system.

It is thus an object of the present invention to provide a System and Method For Improved Medical Billing, Payment, Record Keeping, and Patient Care.

### BRIEF SUMMARY OF THE INVENTION

In accordance with the present invention, there is provided a computer based system for improved medical billing, payment, record keeping and patient care comprising a patient room computer containing a time clock algorithm, an electronic card reader connected to the patient room computer for reading a patient electronic card and for providing patient information contained on the patient electronic card to the patient room computer, a medical practitioner electronic security key operatively coupled to the time clock algorithm, a digital audio recording and storage device coupled to the patient room computer for recording and storing discussions between a medical practitioner and a patient, and a means for activating the digital audio recording and storage device when a medical practitioner enters a patient room.

The foregoing paragraph has been provided by way of introduction, and is not intended to limit the scope of the following claims.

### BRIEF DESCRIPTION OF THE DRAWINGS

The invention will be described by reference to the following drawings, in which like numerals refer to like elements, and in which:

FIG. 1 is a network diagram of one embodiment of the present invention;

FIG. 2 is a timing diagram of validation and billing;

FIG. 3 is a flowchart of total charge calculations;

FIG. 4 is a diagram illustrating a multiple patient billing incentive;

FIG. 5 is a flowchart of copayment charge calculations;

FIG. 6 is a billing flow diagram; and

FIG. 7 is a data diagram of a patient electronic card.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENTS

The present invention improves on the system of Current Procedural Terminology Codes and Evaluation and Management codes used in medical billing today. The present invention uses only one basic code for any encounter with a physician or health care provider. A system of timekeeping and validation is used with this one basic code. The one basic code will allow for up to 15 minutes of service for a flat payment that is billed along with a copayment. After 15 minutes, service is billed at a per minute rate that is determined through pay scale data that is specific to the level of expertise of the service provider. The specific mechanisms of billing are described in more detail later in this specification.

The present invention further uses an electronic identification card that contains vital patient information as well as audio based recordkeeping to streamline the operation of a medical practice. These elements of the present invention will eliminate the need for a front desk in most medical offices, resulting in a lean and highly cost effective operation. When a patient calls a doctor's office, a phone system will guide the patient directly to the Doctor's phone extension, which can be answered by the Doctor's nurse. The present invention will allow a doctor to practice with one nurse instead of the current ratio of at least four to five people per physician, as is typical in medical offices in the United States.

For a continued general understanding of the present invention, reference is made to the drawings. In the drawings, like reference numerals have been used throughout to designate identical elements.

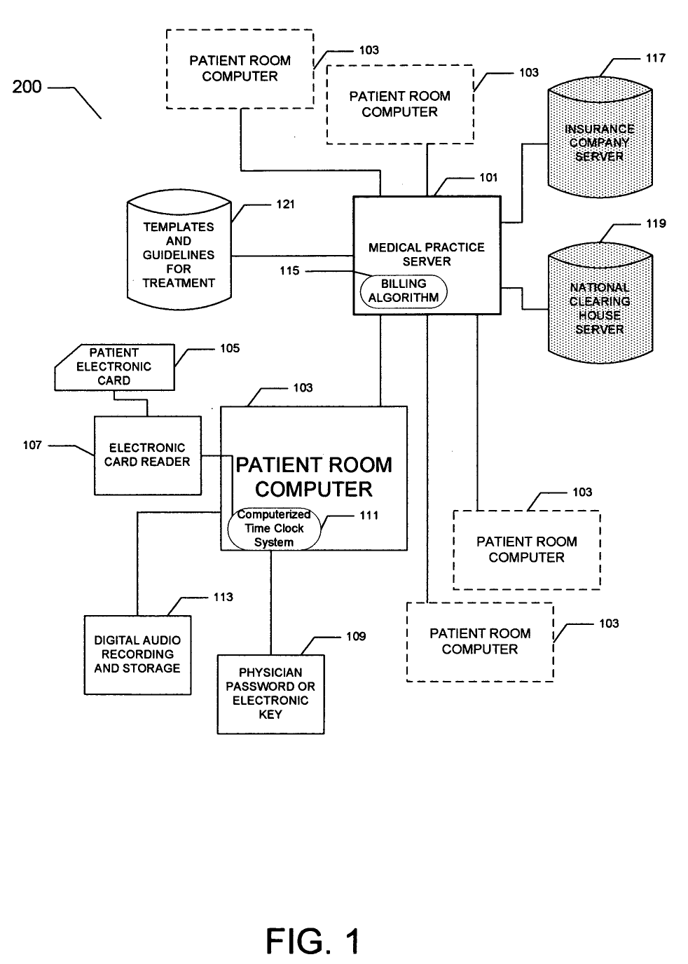

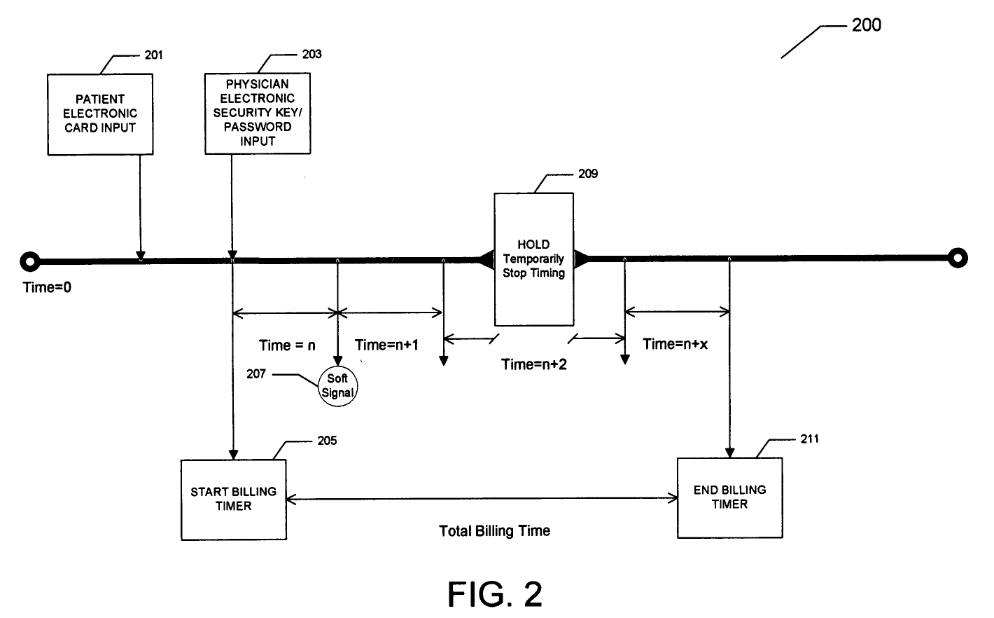

FIG. 1 is a network diagram of one embodiment of the present invention. Referring to FIG. 1, several patient room computers 103 are depicted. Within a patient room of a medical practice, a patient room computer 103 is placed. A patient room computer 103 may, in some embodiments of the present invention, be a personal computer. Each patient room computer 103 maintains a network connection to a medical practice server 101. Each patient room computer 103 contains a computerized time clock system 111 that generates the raw billing information required for patient billing. In some embodiments of the present invention, the computerized time clock system 111 may reside on the medical practice server 101, and be accessed from the patient room computer 103 using networking techniques commonly known to those skilled in the art. The computerized time clock system 111 performs billing interval calculations and timing that are more clearly shown by way of FIG. 2. Billing begins when the computerized time clock system 111 senses the occurrence of two events—the entry of a patient's electronic card 105 and the entry of a physician password or electronic key 109. To prevent billing fraud and abuse, the physician will not be able to charge time without a valid patient electronic card 105 inserted in the electronic card reader 107. The patient's electronic card 105 contains patient insurance information, billing information, historical medical information, medical imaging data, pharmacological data, demographic data, and the like. The patient electronic card 105 is read by an electronic card reader 107 that is connected to the patient room computer 103. The computerized time clock system 111 contains logic to allow a physician to leave the patient room and stop the billing time clock temporarily. The timing of billing and validation is more clearly described by way of FIG. 2. The computerized time clock system 111 may, in some embodiments, provide a visual indication of the time spent through a display, a clock, or the like. The visual indication of time spent may be posted in the patient room in a location that is visible to both the patient and the physician.

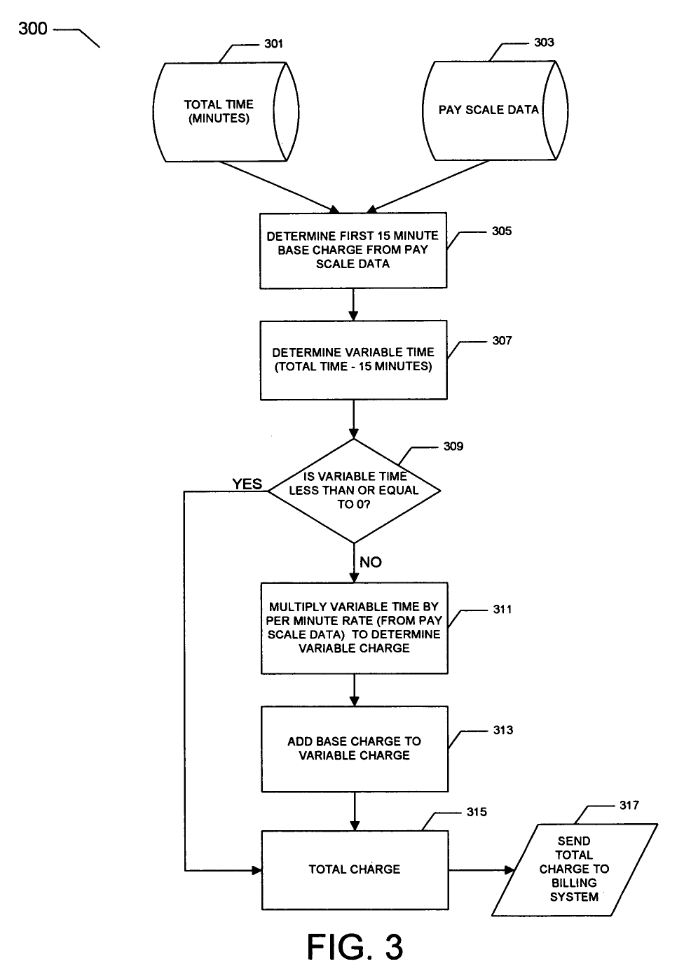

The computerized time clock system 111 collects patient related billing information that has been validated through the use of both a patient electronic card 105 and a physician password or electronic key 109. The billing related information is then sent to the billing algorithm 115 where the total charges are calculated, as will be further described in FIG. 3. In some embodiments of the present invention, the billing algorithm 115 resides on the medical practice server 101. On a scheduled basis, billing information is sent to an insurance company server 117 or a national clearinghouse 119. National clearinghouses process claims for multiple different insurance companies and Medicare. A national clearinghouse may also track the total time a provider may charge per day, preventing abuse and fraud. The insurance company will then send payment to the physician (not shown).

Also connected to the patient room computer 103 is a digital audio recording and storage device 113. The digital audio recording and storage device 113 is well known to those skilled in the art, and allows for the recording of conversations between a medical practitioner and a patient, and subsequent transfer of said recordings to an electronic storage media that may reside on the patient room computer 103. To eliminate complex and expensive medical records, the digital audio recording and storage device 113 allows a physician to record items that are discussed with a patient in the patient room. In some embodiments of the present invention, the digital audio recording and storage device 113 may be temporarily stopped while the computerized time clock system 111 continues to record the total billing time. The digital audio recording and storage device 113 is connected to the patient room computer 103, and contains software to prevent the re-recording or altering of a previously recorded physician-patient session. The digital audio recording and storage device 113 is activated when the physician enters the patient room. Means for activating the digital audio recording and storage device 113 may include switches, sensors, Radio Frequency Identification tags (RFID tags) or other such devices that are well known to those skilled in the art. Audio data recorded on the patient room computer can be stored on media such as a Compact Disc, archived, and accessed for later review should the need arise. The physician may also enter succinct and medically necessary data in the patient room computer 103.

The patient electronic card 105 may also contain medical information such as past history, x-ray reports, lab work, and the like. This medical information may be accessed and retrieved by the physician as required. The information contained in the patient electronic card will eliminate the need for thick charts in medical offices. A Doctor may download pertinent information from the patient electronic card 105 into the medical practice server 101 or the patient room computer 103. A doctor may select to download only the desired information from the patient's electronic card 105. By way of example, and not limitation, a dermatologist may not want information related to a patient's Ob-Gyn records and may elect not to download information related to a patient's Ob-Gyn records. This will effectively eliminate the need for keeping very expensive chart and medical record keeping departments in medical offices and hospitals. Each provider or hospital will keep data related to a particular patient on their main computers to suit their needs. By eliminating costly paper and other record keeping, a physician will be able to see up to twenty patients per day with only one medical assistant or nurse, and may not need further medical office personnel.

The patient room computer 103 will also contain access to templates and guidelines for treatment 121. The templates and guidelines for treatment 121 is an electronic library containing guidelines for the diagnosis, treatment and management of medical illnesses, as established by major medical institutions and authorities. For example, after examining a patient, a physician may request information from the templates and guidelines for treatment 121 related to suggested tests that should be ordered, and what treatment plans should be implemented. The lack of unnecessary documentation and paperwork will allow the physician ample time to review the guidelines and treatment plan with the patient in detail, and provide for delivery of the highest possible level of medical care from each physician to his or her patient. In addition to improved medical care, the system and method of the invention will also reduce medical errors. In some embodiments of the present invention, access to the templates and guidelines for treatment 121 and the subsequent course of action by the physician will be recorded using digital audio recording and storage 113. Daily recordings may be archived to an external media such as a Compact Disc.

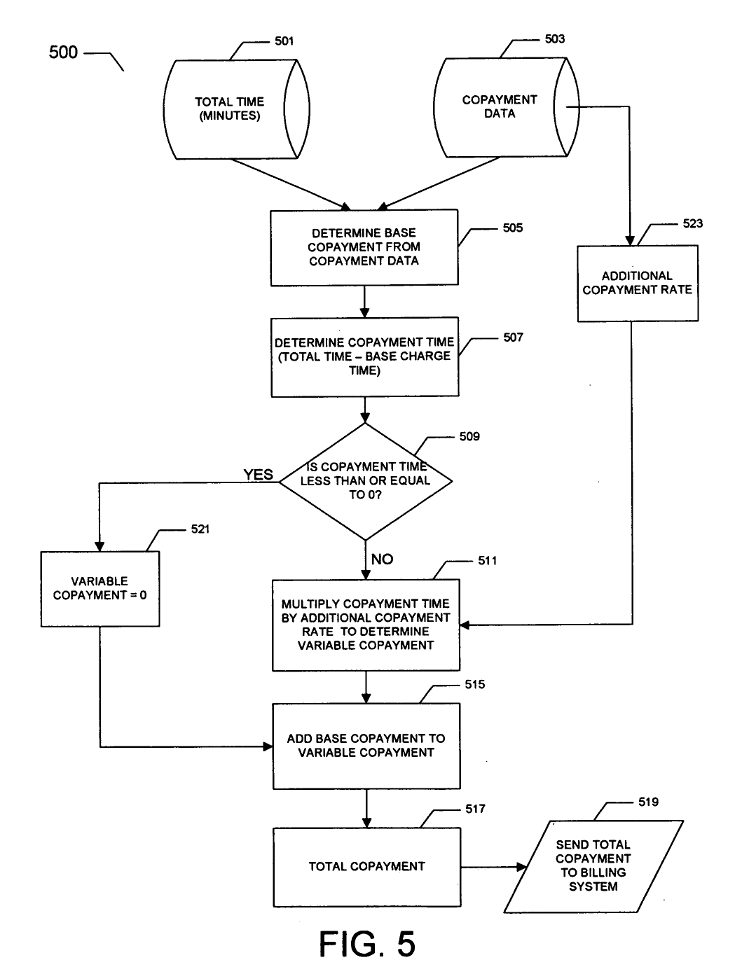

Referring now to FIG. 2, a timing diagram of validation and billing 200 is shown. The basic billing format used provides for a fixed time interval of service to be provided as well as a time based copayment system. As will be further described by way of FIG. 5, a base copayment and a time sensitive additional copayment are used to determine a total copayment. After the base copayment time interval has run, an additional copayment based on a per minute rate is determined.

As shown in FIG. 2, patient electronic card input 201 is received by an appropriate electronic card reader 107 (FIG. 1). At this point in the billing process, a patient has entered the patient room and inserted their electronic card into an electronic card reader 107 (FIG. 1). No billing has occurred at this point. When a physician enters the patient room, the billing timer will start 205 by a physician electronic key/password input 203. Both the patient electronic card input 201 and the physician electronic key/password input 203 are required for the billing timer to start. In some embodiments of the present invention, a timer or clock displaying the elapsed billing time is displayed in the patient room. At the end of the first billing interval n, a soft signal 207 is provided in the patient room. The soft signal 207 may, in some embodiments, be a bell, a tone, a chime, a visual indicator, or the like. The activation of a soft signal 207 serves to alert both the patient and the physician of the end of the first billing interval n, which, in some embodiments, may be the end of the base copayment time interval. The billing timer continues to run, and, in some embodiments, a soft signal 207 may be activated at fixed intervals of time throughout the physician patient interaction. Should the doctor leave the room for a reason not related to the patient he is seeing, a HOLD function 209 will allow the doctor to temporarily stop the billing timer. The HOLD function 209 may, in some embodiments, be a button or a software user interface function. Upon returning to the patient room, the doctor will use the HOLD function 209 to re-activate the billing timer. At the completion of the patient visit, the doctor will end the billing timer 211 through a software user interface function or through a hardware interface. The total billing time, as well as the information retrieved from the patient electronic card input 201 and the physician specific electronic key/password input are sent from the patient room computer 103 (FIG. 1) to a billing algorithm 115 (FIG. 1).

Referring now to FIG. 3, a flowchart of total charge calculations 300 is depicted. The inputs to the total charge calculations are the total time (minutes) 301 and pay scale data 303. The total time (minutes) 301 are received from the patient room computer 103 (FIG. 1), and contain the total billing interval for the patient visit, as previously described by way of FIG. 2. The present invention allows for different pay scales for different service providers based on their experience and level of training. By way of example, and not limitation, a physician assistant or nurse practitioner would be billed at $20 for up to fifteen minutes and $1 for each additional minute. A general practitioner would be billed at $30 for the first fifteen minutes and $1.50 for each additional minute. A board certified specialist with three years of residency training would be billed at $40 for the first fifteen minutes and $2 for each additional minute. A sub-specialist with two to three years of fellowship training would be billed at $50 for the first fifteen minutes and $3 for each additional minute. A general surgeon would be billed at $40 for the first fifteen minutes and $2 for each additional minute during the surgical procedure. A specialist surgeon would be billed at $50 for the first fifteen minutes and $3 for each additional minute during the procedure. In some embodiments of the present invention, a service provider may desire to charge extra payments in addition to their proposed charges. To encourage free market spirit, the present invention will allow a service provider to charge extra provided that the extra charges are posted in a visible place so that patients are aware of these charges. In addition, in some embodiments of the present invention, patients will be responsible for 100% of these extra charges. To add incentives to medical service providers, a small raise may be periodically added to the provider's per minute billable rate if the provider performs certain actions such as maintaining their qualifications by way of peer reviews, board certification, continuing medical education, and the like. Other events that may provide a small raise to the medical service provider's per minute billable rate may include maintaining compliance with guidelines and standardized protocols, results of patient satisfaction surveys, efficiencies as judged by minimum adverse outcomes, and the like. In these examples of pay scale data 303, the first fifteen minutes of billing time is considered the base charge, and the remaining per minute charges are the variable charges. As seen in FIG. 3, the total time in minutes 301 and the pay scale data 303 are inputs to the total charge 315. In step 305, the first fifteen minute base charge is determined from pay scale data 303. In step 307, the variable time is determined by subtracting fifteen minutes from the total time. In step 309, if the variable time is less than or equal to zero, the base charge is the total charge 315. In step 307, if the variable time is greater than zero, step 311 commences where the variable time is multiplied by the per minute rate that is defined in the pay scale data 303 to determine the variable charge. In step 313, the base charge is added to the variable charge to equal the total charge 315. The total charge 315 is sent to the billing system in step 317. The process of total charge calculations 300 is repeated for each physician patient encounter.

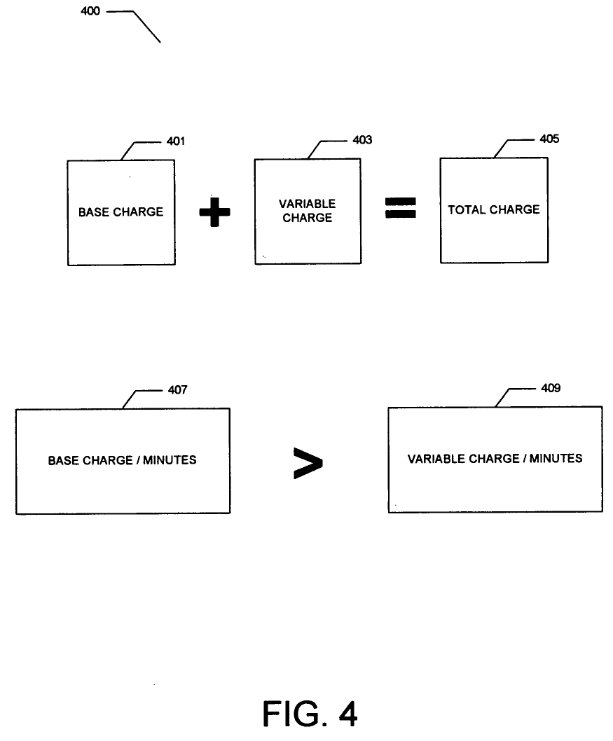

FIG. 4 is a diagram illustrating a multiple patient billing incentive 400 that is used in some embodiments of the present invention. To prevent a physician from spending too much unnecessary time with one patient in an attempt to increase billable time, a technique may be used to provide a disincentive for such behavior. The basic billing formula that has been described in this specification is a base charge 401 plus a variable charge 403 equals a total charge 405. This billing formula is further described in the flowchart provided in FIG. 3. The multiple patient billing incentive 400 sets the per minute base charge 407 at more than the per minute variable charge 409. This technique provides an incentive for a physician to see multiple patients. For example, one sixty minute billing interval with one patient would pay less than four fifteen minute billing intervals with four patients, despite the fact that the total amount of billable time is the same. This is caused by the per minute base charge 407 being greater than the per minute variable charge 409.

Referring now to FIG. 5, a flowchart of copayment charge calculations is shown. The inputs to the total copayment calculations are the total time (minutes) 501 and copayment data 503. Copayment data 503 is information provided by an insurance company that defines what the copayment amount is for a particular service under a specific insurance plan. The total time (minutes) 501 are received from the patient room computer 103 (FIG. 1), and contain the total billing interval for the patient visit, as previously described by way of FIG. 2. In step 507, the copayment time is determined by subtracting the base charge time from the total time. In step 509, if the copayment time determined in step 507 is less than or equal to zero, the variable copayment is set to equal zero in step 521. If, in step 509, the copayment time is greater than zero, a variable copayment is calculated in step 511 by multiplying the copayment time by an additional copayment rate that is determined in step 523 from the copayment data 503. In step 515, the base copayment and the variable copayment are added together to yield a total copayment 517. The variable copayment serves to control unnecessary time between the patient and the physician by providing a disincentive for the patient to take up unnecessary time. The sum of the base copayment and the variable copayment determined in step 515 is the total copayment 517. The total copayment 517 is sent to the billing system in step 519. The process of total copayment calculations 500 is repeated for each physician patient encounter.

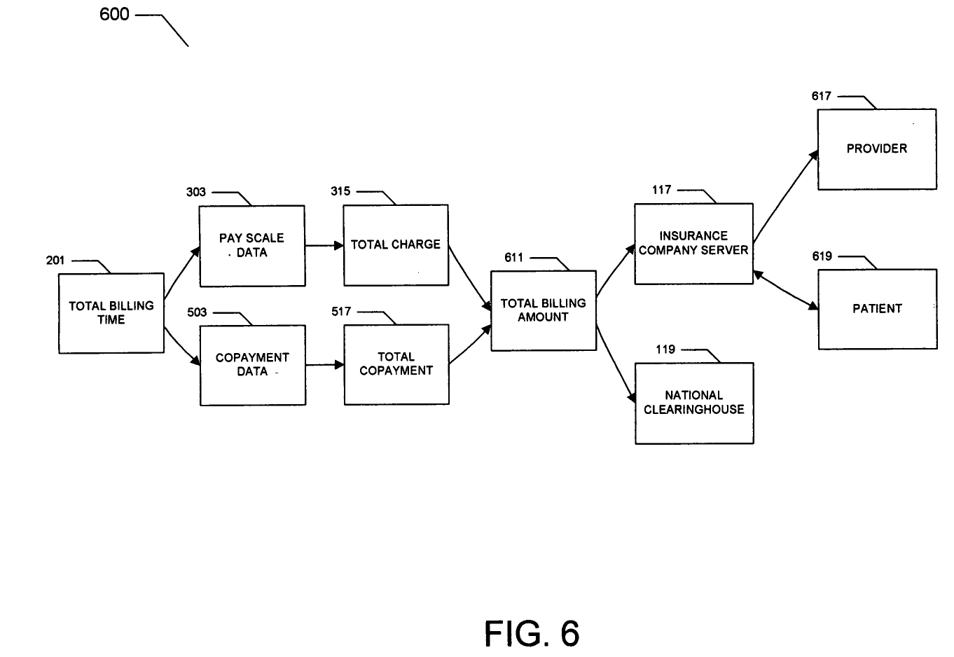

Referring now to FIG. 6, a billing flow diagram is depicted. The total billing time 201, as determined through the timing elements described by way of FIG. 2, is processed with pay scale data 303, as described by way of FIG. 3, to determine a total charge 315. The total billing time 201 is also processed with copayment data 503 to determine a total copayment 517. The total charge 315 and the total copayment 517 constitute a total billing amount 611. The total billing amount 611 will be sent to an insurance company server 117 or a national clearinghouse 119 for processing. The insurance company will in turn validate and process the billing related data, and reimburse the provider 617 for the full amount of services rendered to the patient 619. The full amount includes the copayment amount. In turn, the insurance company will bill the patient for the copayment amount. This method of billing for copayments will serve to eliminate the practice by some providers of writing off copayments as a way to attract new patients.

As part of the billing method of the present invention, a physician will not be allowed to engage in ancillary services such as X-rays, lab work, Magnetic Resonance Imaging, and the like. Under the current CPT/ICD system, physicians often times engage in ancillary services to help cover the high overhead costs caused by the current CPT/ICD system. The practice of physicians engaging in ancillary services, combined with the practice of defensive medicine, leads to abuse of ancillary services. By eliminating the current CPT/ICD system, medical office overhead costs will be reduced by up to 80%, providing an increase to the physician's personal income. This increase in a physician's income will be balanced by the prohibition of physician's engaging in ancillary services. The patient will in turn have a copayment for each ancillary service performed. These practices will lead to a drastic reduction in the use of ancillary services, resulting in billions of dollars in savings to the medical system in the United States.

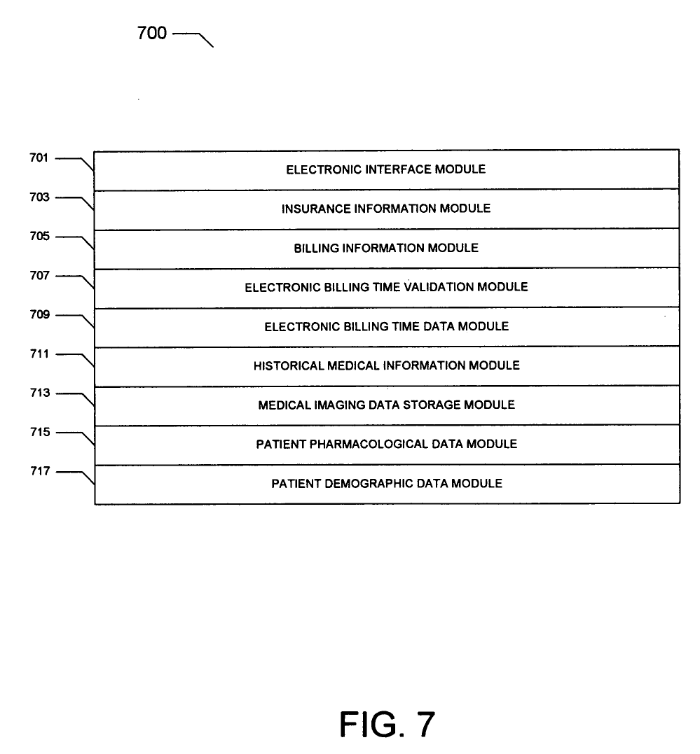

Turning now to FIG. 7, a data diagram 700 of a patient electronic card 105 is depicted. The patient electronic card 105 may, in some embodiments of the present invention, be a smart card. A smart card contains electronic memory, and in some instances, a microprocessor. The patient electronic card 105 may, in some embodiments of the present invention, contain a security identification element such as a Radio Frequency Identification Tag (RFID tag), fingerprint information, DNA information, or the like. A security identification element is any component that serves to uniquely identify the owner of the patient electronic card 105.

The patient electronic card 105 contains a great deal of information related to a patient, and could be used throughout the lifetime of the patient.

The patient electronic card 105 may contain some or all of the modules described herein. An electronic interface module 701 provides the communications protocol and encryption standards necessary to communicate information from the patient electronic card to an external computer system such as the patient room computer 103 described by way of FIG. 1. An insurance identification module 703 contains information related to the patient's current insurance provider as well as policy specific information. The insurance information contained in the insurance identification module 703 may include the insurance company code, Medicare information, and new patient setup information. A patient electronic card 105 that contains an insurance identification module 703 may be used as a lifetime card that an individual has from birth. The billing information module 705 contains information related to the patient's billing records, payment history, and the like. The electronic billing time validation module 707 interacts with the computerized time clock system 111 to authorize and validate billing time charges, as previously described by way of FIGS. 1 and 2. The electronic billing time data module 709 captures billable time recorded by the time clock algorithm. The historical medical information module 711 contains the patient's medical history, and is partitioned by topic or subject matter in a way that allows a specific medical practitioner to access only subject matter that is appropriate for the procedure or treatment being provided. The medical imaging data storage module 713 contains digital x-ray images, Magnetic Resonance Images, and other medical images that are relevant to the historical medical information contained in the medical information module 711. The patient pharmacological data module 715 contains information related to patient drug allergies, current and past prescription information, and the like. The patient demographic data module 717 contains patient information such as address, date of birth, family status, and the like. Various embodiments of the present invention may use some or all of the modules described herein. Other modules may also be added, as may become evident to those skilled in the art.

It is, therefore, apparent that there has been provided, in accordance with the various objects of the present invention, a system and method for improved medical billing, payment, record keeping and patient care.

While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

I claim:

1. A computer based system for improved medical billing, payment, record keeping and patient care comprising:
a.) a patient room computer containing a computerized time clock system;
b.) an electronic card reader connected to the patient room computer for reading a patient electronic card and for providing patient information contained on the patient electronic card to the patient room computer;
c.) a medical practitioner electronic security key operatively coupled to the computerized time clock system;
d.) a digital audio recording and storage device coupled to the patient room computer for recording and storing discussions between a medical practitioner and a patient; and
e.) a means for activating the digital audio recording and storage device when a medical practitioner enters a patient room.

2. The computer based system of claim 1 wherein the computer based system further comprises a medical practice server coupled to the patient room computer.

3. The system of claim 1 wherein the computer based system further comprises templates and guidelines for treatment.

4. The computer based system of claim 1 wherein the medical practitioner electronic security key is a password.

5. The computer based system of claim 1 wherein the computer based system further comprises a billing algorithm.

6. The computer based system of claim 1 wherein the computer based system further comprises an electronic interface to an insurance company server.

7. The computer based system of claim 1 wherein the computer based system further comprises an electronic interface to a national clearing house server.

8. A computerized time clock system for medical billing comprising:
a.) a patient electronic card input;
b.) a physician electronic security key input;
c.) a billing timer that is activated when both a valid patient electronic card input and a valid physician electronic security key input are received by the computerized time clock system;
d.) a hold function to temporarily stop and restart the billing timer;
e.) a soft signal to alert a medical practitioner and a patient to passage of a pre-programmed time interval;
f) a means for stopping the billing timer upon completion of a patient visit; and
g.) a means for transferring billing information collected by the computerized time clock system to a medical billing system.

9. The system of claim 8 wherein the soft signal is audible.

10. The system of claim 8 wherein the soft signal is visual.

11. A method of billing for medical services comprising the steps of:
a.) Preparing pay scale data that contains pay scales for various medical practitioners;
b.) Recording a total billing time for medical services given by a medical practitioner to a patient on a specific time and date;
c.) Establishing a base time and a base charge for medical services given by the medical practitiorier from the pay scale data;
d.) Determining a variable time for medical services by subtracting the base time from the total billing time;
e.) Determining a variable charge for medical services by multiplying the variable time by pay scale data for the medical practitioner;
f) Determining a total charge for medical services by adding the base charge to the variable charge; and
g.) Sending the total charge for medical services to a medical billing system for use in producing an invoice for medical services.

12. The method of claim 11 wherein the base charge divided by the base time is greater than the variable charge.

13. A method of determining a medical copayment comprising the steps of:
a.) Preparing copayment data that contains a base charge time, a base copayment, and an additional copayment rate;
b.) determining a copayment time by subtracting a total billing time for medical services given by a medical practitioner to a patient on a specific time and date from the base charge time;
c.) determining a variable copayment by multiplying the copayment time by the additional copayment rate;
d.) determining a total copayment by adding the base copayment to the variable copayment; and
e.) Sending the total copayment to a medical billing system for use in producing an invoice for medical services.

14. A method of billing for medical services comprising the steps of:
a.) determining a total billing amount by adding a total charge to a total copayment;
b.) issuing a payment for the total billing amount by an insurance company to a medical practitioner; and
c.) billing of the total billing amount by an insurance company to a patient of the medical practitioner.

15. A patient electronic card for improved medical billing, payment, record keeping and patient care comprising:
a.) an insurance information module that contains medical insurance information;
b.) memory for storing the medical insurance information; and
c.) a security identification element operatively coupled to said patient electronic card.
